(19) United States
(12) Patent Application Publication
(10) Pub. No.: US 2019/0297912 A1
(43) Pub. Date: Oct. 3, 2019

(54) METHOD FOR PRODUCING A CHEWING GUM COMPOSITION WITH NO-BAKE CHEWING GUM

(71) Applicant: ROQUETTE FRERES, Lestrem (FR)

(72) Inventor: André BUSOLIN, LAMBERSART (FR)

(21) Appl. No.: 16/465,687

(22) PCT Filed: Nov. 30, 2017
(86) PCT No.: PCT/FR2017/053289

§ 371 Date: May 31, 2019

(30) Foreign Application Priority Data
Dec. 1, 2016 (FR) 1661808

(51) Int. Cl. A23G 4/10

(52) U.S. Cl. CPC A23G 4/10; A23V 2002/00; A23V 2200/3324; A23V 2200/15; A23V 2250/6404; A23V 2250/6416; A23V 2200/222; A23V 2250/5114

(57) ABSTRACT

The present invention concerns a method for producing a chewing gum composition containing a fat-free and gelatin-free chewing gum, comprising the following steps: 1) preparing the liquid phase, consisting of polyol and starch syrups, 2) optionally, adding glycerin and/or emulsifier and/or flavours, 3) introducing a powder fraction consisting of non-cariogenic ingredients into the liquid phase obtained in this way, and 4) introducing the gum base, and the chewing gum composition obtained in thus way, in which the fraction of non-cariogenic ingredients comprises powdered polyols with a chosen particle size.

### TECHNICAL FIELD OF THE INVENTION

The present invention relates to a process for producing a sugar-free chewing gum, more particularly a chewing gum composition, with a chewing paste of which the fat content has been reduced, or even totally eliminated, the sugar-free chewing paste being produced without a cooking phase.

The present invention thus relates to a process for producing said chewing gum without cooking and without exposing the components of the composition to high temperature.

### CONTEXT OF THE INVENTION

There are numerous confectionery products. They all have in common the cooking of sugar and/or of polyols and the mixing thereof with other ingredients to obtain different specialities and flavors.

These other ingredients are conventionally sweeteners, fats, emulsifiers, flavorings, dyes, mineral and/or organic acids and/or bases and salts thereof and one or more thickening and/or gelling hydrocolloids of plant or animal origin, such as gum arabic, gelatin, pectin, carrageenans, alginates, celluloses and starch and its derivatives.

The chewing pastes targeted are characterized by the presence of fats which gives them a soft and flexible texture, as opposed to cooked sugars.

Chewing pastes also contain incorporated air and sugar which is, in general, partially crystallized in order to obtain a short texture.

Glucose syrups contribute to the texture by facilitating the formation of the gelled network and also good overrun of the product.

Chewing pastes are very well liked by consumers because of their considerable chewability property which makes them similar to a chewing gum.

Unlike chewing gum, chewing paste dissolves completely in the mouth after chewing and leaves no non-consumable residue. Thus, unlike chewing gum, chewing paste does not comprise gum base in its composition.

Chewing pastes can be obtained by cooking a mixture of sugar and glucose syrup, to which fat has been added.

Chewing Pastes

Conventionally, standard chewing pastes contain between 4% and 8%, sometimes 10%, of fat. The cooked mass can subsequently be aerated to lighten it by means of one of the processes well known to confectioners, for instance pulling, beating which may be under pressure, mixing under pressure, extrusion. It is this aeration and the presence of fats which give chewing pastes their characteristic texture.

The fat used in confectionery items may be of different origin. It is usually hydrogenated palm oil. In certain cases, it may be coconut oil.

Palm oil is currently highly used in the food-processing industry (80% of applications are involved). Its very low production costs, and its ability to preserve foods and to make them soft make this product a key element for producers.

Palm oil should have the name “palm fat” since it is hard at ambient temperature because of its richness in saturated fatty acids (which is much higher than that of animal fats such as butter, for example).

It is found in a great diversity of products, such as cookies, confectionery items, industrial breads, chocolate bars, cereals, margarine, ice cream, etc. (but also in certain soaps, fragrances, cosmetics, etc.).

Like trans fatty acids, saturated fatty acids also cause bad cholesterol to increase. Thus, adding fat rich in saturated fatty acids (in this case palm oil) to a food that is already rich in saturated fatty acids is bad for the health.

What is more, palm oil production is associated with massive deforestation, greenhouse gas emissions and a negative impact on biodiversity.

Recently, a reversal of trend has been observed. In order to combat these harmful ecological and health-based effects, several big chains (fast-food chains, superstores, food-processing companies, etc.) have chosen to significantly reduce, or even definitively eliminate, the use of palm oil in the production of their food products.

Chewing Gums

Chewing gum, for its part, is conventionally a mixture of two phases: a liquid phase (syrup, diluted sugars) and a solid phase composed of gum base and granulated sugar.

The standard formula of chewing gum composition is:
20% of gum base,
60% of a crystalline phase (example: sucrose powder),
20% of syrup (18% syrup, 1% flavoring, 1% other substances).

In standard recipes for producing sugar-free chewing gum, the gum base typically represents between 28% and 40% of the ingredients used in the production of the centers, the remainder consisting mainly of polyols, and to a lesser extent of intense sweeteners of aspartame or acesulfame-K type, flavorings, and antioxidants in certain cases.

The nature of the gum base is also adapted to the type of chewing gum produced.

It may also comprise:
Synthetic and/or natural elastomers, such as polyisoprene, polyvinyl acetate, polyisobutylene, latexes, resins such as terpene resins, polyvinyl alcohols and esters,
fats or waxes, for instance lanolin, partially hydrogenated or non-hydrogenated plant oils, fatty acids, partial esters of glycerol, paraffin, microcrystalline waxes,
bulking agents such as talc, calcium carbonate,
elastomer plasticizers such as glyceryl triacetate, glyceryl monostearate, rosin derivatives,
emulsifiers such as lecithin, sorbitol esters,
dyes or bleaching agents,
antioxidants,
non-stick agents such as mannitol.

Bulk sweeteners consist of non-fermentable monosaccharides that may be chosen from isomaltulose, allulose, xylose, xylulose, arabinose, leucrose, tagatose, trehalulose or raffinose.

Preferably, the bulk sweeteners consist only of polyols.

Polyols play a crucial role in the production of sugar-free chewing gum centers, both in the final quality of the product obtained (impact of the sweet taste and the long-lasting effect, impact on aromatization, crunchiness, hardness, chewability) and also in the process for producing said centers.

Typically, the principal polyols used in the production of sugar-free chewing gum or bubblegum are maltitol, sorbitol, mannitol and xylitol.

These polyols are used both in powdery crystalline form and in liquid form in the formulation of these centers.

A sugar-free chewing gum composition generally contains between 65% and 80% of polyols, in pulverulent and/or liquid form.

The recipe of the gum base often remains secret since it is not constant. It varies according to the price of the raw material.

The constituent ingredients of the gum base are water-insoluble.

On the other hand, the majority of the other constituent ingredients of chewing gums are water-soluble (that is to say soluble in saliva in this case). After 3 to 4 minutes of chewing time, the compounds are extracted (dissolved) by the saliva, hence the loss of taste of the chewing gum.

The gum base and a few flavorings, which are not water-soluble, and/or which have remained trapped in the matrix consisting of the gum base, remain in the mouth.

From the production process point of view, flavorings, sweeteners or sugar and also various additives and production aids (such as dye, emulsifier, stabilizer, bicarbonate) are added to the gum base.

The ingredients and the gum base are mixed in a kneading machine for 15 to 20 minutes.

At the end of kneading, the paste reaches a temperature of approximately 50° C.

The chewing gum paste is placed inside an extruder. Once well pressed, it then forms more or less thick strips. The strips then pass through the roller and are cut into sticks or cores also known as centers.

After cooling, the sticks or the centers are maintained at a controlled temperature and humidity for 6 to 48 hours. This phase is highly controlled, since the quality of the chewing pastes depends on it.

The sticks are wrapped in an aluminum wrapping to conserve all their taste. There are then placed in packets. The centers are sweet-coated before being packaged in cardboard or plastic containers.

Irrespective of the age of the consumers, there is a constant desire to have quality products.

The quality of chewing gums is measured by several parameters, including the texture of the chewing gum (rather hard or, on the contrary, rather soft, persistent crunchiness of the sweet-coated centers during chewing) and the taste (sweet taste, refreshing effect or not, persistence of the flavor during chewing).

Indeed, consumers very often complain that both the crunchiness and the taste disappear too quickly during chewing.

Chewing gums contain a significant crystalline phase, which may represent up to 80% by dry weight of the ingredients used.

This crystalline phase gives products which have a hard bite during chewing, and take a long time to be hydrated.

The Chewing Gum/Fat-Free Chewing Paste Combination

In its patent application WO 2016/001191, the applicant company had proposed advantageously replacing the fat in confectionery items, in particular of chewing paste type, with a combination of a starch hydrolysate and a plant fiber, which retained the organoleptic qualities, in particular gustative, olfactory, visual and tactile qualities, at least equivalent to, or even superior to, those of the conventional confectionery items containing fat.

Said confectionery item was characterized in that it comprised from 0.1% to 25% of a starch hydrolysate, preferably from 2% to 10%, more preferentially from 3% to 8%, the percentages being expressed by weight relative to the total weight of the confectionery item.

It was also characterized in that it comprised from 0.1% to 50% of fibers, preferably from 1% to 10%, more preferentially from 1% to 6%, the percentages being expressed by weight relative to the total weight of the confectionery item.

The notion of confectionery item could be understood, in application WO 2016/001191 as a composition of chewing gum combined with a chewing paste.

The fat-free chewing paste was used as a substitute for the crystalline phase of the chewing gum, making it possible to obtain a texture that was more flexible, and therefore easier to hydrate.

This capacity to dissolve faster had enabled, during tasting, a more instantaneous release of the flavorings and/or of the acids contained in the recipe. Thus, the aromatic perception was faster and more intense.

According to one embodiment of patent application WO 2016/001191, the confectionery item could be a chewing gum containing a gum base, in particular from 5% to 50% by weight of gum base, and a mixture of a starch hydrolysate and a plant fiber.

According to one particular embodiment, said chewing gum had a reduced polyol content.

This decrease in the crystalline phase (polyols in the majority of cases) made it possible to greatly reduce the intestinal problems (bloating, flatulence, laxative effect) associated with an excessive consumption of polyols.

Conventionally, the production of chewing gum requires very specific and expensive equipment, consisting at least of a kneading machine, an extruder and a roller.

In order to be able to produce a chewing gum containing at most 25% of gum base, the applicant company, in its patent application WO 2016/001191, had proposed a production process comprising the following steps:
mixing the chewing paste according to the invention with the gum base,
rolling or extruding the mixture, and
recovering the chewing gums or directly packaging them.

As regards the preparation of the chewing paste, it comprises the steps of:
mixing from 0.1% to 25% of a starch hydrolysate, preferably from 2% to 10%, more preferentially from 3% to 8%, the percentages being expressed by weight relative to the total weight of the confectionery item, with from 0.1% to 50% by weight of a plant fiber, preferably from 1% to 10%, more preferentially from 1% to 6%, the percentages being expressed by weight relative to the total weight of the confectionery item,
cooking the mixture at a temperature of between 100 and 150° C. until the desired solids content is obtained.

According to patent application WO 2016/001191, and for a continuous production, it was preferred to disperse the sweeteners, the starch hydrolysate and the fibers in a mixing tank, to preheat this mixture to approximately 70-80° C. in order to dissolve the sweeteners, to cook the mixture on a cooker at a temperature of between 100 and 150° C. depending on the desired texture and the type of confectionery item prepared, then to add the emulsifier, the overrun agent(s), the flavorings, the dyes, the active ingredients and the intense sweeteners.

The cooking time depended on the material used.

The cooking could be carried out on jacketed cookers at atmospheric pressure, under partial or total vacuum or under pressure, or continuously on high-pressure cookers such as tubular exchangers, plate exchangers or jet-cookers.

After cooking, the emulsifier, the overrun agent(s), the flavorings, dyes, acids and others were added to the hot syrup at a temperature of between 60 and 90° C., the mixture was then cast on a cooling plate, and pulling was carried out for approximately one minute at 50-60 movements.

Once the pulling had been carried out, the confectionery items obtained were shaped and wrapped.

Be that as it may, the solution proposed by the applicant company in its application WO 2016/001191, as effective as it is, does not completely succeed in dispensing with the conventional steps of cooking the chewing paste in order to produce said chewing gum.

Wishing to further improve the prior art and especially to meet the always more demanding expectations of consumers, the applicant therefore endeavoured to develop a process for producing a chewing gum combining a fat-free chewing paste, said process requiring just one mixing phase and not requiring the use of a cooker.

### SUMMARY OF THE INVENTION

The present invention relates to a process for producing a chewing gum composition containing a fat-free and gelatin-free chewing paste, comprising the following steps:
1) preparing the liquid phase, composed of starch and polyol syrups,
2) optionally, adding glycerol and/or emulsifier and/or flavorings,
3) introducing into the liquid phase thus obtained a powder fraction composed of non-cariogenic ingredients, and
4) introducing the gum base,

characterized in that said process is carried out at a temperature of less than 100° C., preferably at a temperature of less than 90° C., in particular at a temperature of between 30 and 80° C., preferably between 50 and 80° C., for example at approximately 50° C.

The process according to the invention may comprise a step 5) of adding an additional powder fraction composed of non-cariogenic ingredients.

Preferably, at least 50% of the powder fraction composed of non-cariogenic ingredients is introduced in step 3) and the remainder of the powder fraction is introduced in step 5).

The polyol syrups introduced into the liquid phase may be chosen from maltitol, sorbitol, mannitol, erythritol, xylitol, iditol, isomalt and lactitol syrups, and hydrogenated glucose syrups, alone or as a mixture with one another, and are more particularly maltitol or sorbitol syrups.

Preferably, the polyol syrup is introduced into the chewing gum composition during step 1) in an amount of between 15% and 60% by weight of the chewing gum composition, preferably between 20% and 50%, between 25% and 45% or between 30% and 40%, for example approximately 30% or approximately 40%, in particular when the polyol syrup has a solids content of between 80% and 90% by weight.

Preferentially, the polyol syrup is introduced into the chewing gum composition during step 1) in an amount of between 20% and 60% by weight of the chewing gum composition, for example between 30% and 50%, preferably approximately 40% by weight of the chewing gum composition, in particular when the polyol syrup has a solids content of between 80% and 90% by weight.

Even more preferentially, the polyol syrup is introduced into the chewing gum composition during step 1) in an amount of between 15% and 45% by weight of the chewing gum composition, preferably between 20% and 45%, or between 30% and 45% or between 25% and 35%, for example approximately 30%, in particular when the polyol syrup has a solids content of between 80% and 90% by weight.

The starch which is introduced into the liquid phase according to the present invention can be chosen from native starches, gelatinized starches and starch derivatives, and is more particularly a starch hydrolysate.

Preferably, the starch hydrolysate is a maltodextrin, preferably a maltodextrin which has a DE (Dextrose Equivalent) of less than 10, preferentially less than 5, and even more preferentially equal to 2. Preferably, the maltodextrin is introduced into the liquid phase in a content of between 2% and 7% by weight of the chewing gum composition, for example between 2% and 6%, or between 3% or 5%, preferably approximately 3% or 5% by weight of the chewing gum composition. Preferentially, the maltodextrin is introduced into the liquid phase in a content of between 3% and 6% by weight of the chewing gum composition, for example about 5% by weight of the chewing gum composition. Even more preferentially, the maltodextrin is introduced into the liquid phase in a content of between 2% and 7% by weight of the chewing gum composition, for example between 2% and 6%, between 2% and 5% or between 2% and 4%, preferably approximately 3% by weight of the chewing gum composition.

In one aspect of the present invention, the weight ratio between the amount of water introduced by the polyol syrup and the amount of starch and/or of starch hydrolysate (in particular maltodextrin) is between 1 and 4, preferably between 1 and 2, more preferentially between 1 and 1.5.

The non-cariogenic ingredients of the powder fraction introduced into the liquid phase that are used in the present invention may be chosen from a sugar, a polyol, a soluble fiber, minerals and mixtures thereof.

Preferably, the powdered polyol is chosen from maltitol, sorbitol, mannitol, erythritol, xylitol, iditol, maltitol, isomalt and lactitol, and is more particularly maltitol. Preferentially, the polyol is a dehydrated maltitol syrup. The polyol is introduced in a content of between 0.1% and 60% by weight of the chewing gum composition, for example between 1% and 55%, between 2% and 50% or between 5% and 50%. Preferably, the polyol is introduced in a content of between 0.1% and 50% by weight of the chewing gum composition, for example between 1% and 40%, between 2% and 30% or between 3% and 20%, more preferentially from 5% to 15%. Preferentially, the polyol is introduced in a content of between 20% and 60% by weight of the chewing gum composition, for example between 25% and 55% or between 30% and 55%, preferentially from 35% to 50%.

The soluble fiber according to the present invention is a soluble plant fiber which may be chosen from fructans such as fructooligosaccharides (FOSs) and inulin, glucooligosaccharides (GOSs), isomaltooligosaccharides (IMOs), trans-galactooligosaccharides (TOSs), pyrodextrins, polydextrose, branched maltodextrins, indigestible dextrins and soluble oligosaccharides derived from oleaginous or protein-producing plants. Preferably, the soluble plant fiber is a branched maltodextrin The fiber can be introduced in a content of from 0% to 55%, preferably 0.1% to 50% by weight of the chewing gum composition, for example between 1% and 45%, between 2% and 40%, between 3% and 35%, more preferentially from 10% to 30% and even more preferentially from 15% to 25%.

The non-cariogenic ingredient powder(s) according to the present invention can have an average particle size of less than 300 microns, preferably less than 150 microns and even more preferentially less than 100 microns. Preferably, the non-cariogenic ingredient powder(s) have an average particle size of between 10 and 300 microns, between 10 and 200 microns or between 10 and 100 microns, preferably between 20 and 200 microns or between 20 and 100 microns.

According to one aspect of the invention, the gum base can be introduced in a content of between 10% and 25%, between 12% and 23%, between 15% and 20% by weight of the chewing gum composition, preferably approximately 18%.

According to one aspect of the present invention, from 0.1% to 8% of functional ingredients, by weight of the chewing gum composition by weight of the chewing gum composition, preferentially from 0.1% to 3% of at least one flavoring, are introduced into the liquid phase.

Another aspect of the present invention relates to the chewing gum composition containing a chewing paste, said chewing paste containing a powder fraction composed of non-cariogenic ingredients comprising powdered polyols having an average particle size of less than 300 microns, preferably less than 150 microns, even more preferentially less than 100 microns, obtained by means of a process according to the invention.

Preferably, the chewing gum composition containing a chewing paste comprises between 20% and 60%, by dry weight of the chewing gum composition, of polyols and of starch, preferably of maltodextrin and of maltitol, and a final moisture content of at least 2%, preferentially between 15% and 45% dry weight of liquid phase and a final moisture content of between 4% and 8%.

Preferably, the chewing gum composition containing a chewing paste comprises:
the polyol originating from polyol syrup in an amount of between 10% and 55% by weight of the chewing gum composition, preferably between 15% and 45%, between 20% and 40% or between 25% and 35%; the polyol preferably being maltitol;
the starch in an amount of between 2% and 7% by weight of the chewing gum composition, for example between 2% and 6%, or between 3% or 5%, preferably approximately 3% or 5% by weight of the chewing gum composition; the starch preferably being maltodextrin;
the fiber in an amount of from 0% to 55% by weight of the chewing gum composition, for example between 1% and 45%, between 2% and 40%, between 3% and 35%, more preferentially from 10% to 30% and even more preferentially from 15% to 25%; preferably in powder form; the fiber preferably being a branched maltodextrin;
the polyol powder is introduced in an amount of between 0.1% and 60% by weight of the chewing gum composition, preferably between 1% and 55%, between 2% and 50% or between 5% and 50%; the polyol being maltitol; and
the gum base is present in the chewing gum composition in an amount of between 10% and 25%, between 12% and 23%, between 15% and 20% by weight of the chewing gum composition, preferably approximately 18%.

### DETAILED DESCRIPTION OF THE INVENTION

The present invention relates to a process for producing a chewing gum composition containing a chewing paste produced without a cooking phase, in particular without it being necessary to cook the chewing paste in order to evaporate off a part of the water, this chewing paste preferably being fat free and gelatin free, and in particular said chewing paste being sugar-free.

The chewing paste according to the present invention is defined as being composed of a liquid phase comprising starch and polyol syrups, optionally glycerol and/or an emulsifier, and/or flavorings and also a powder fraction composed of non-cariogenic ingredients.

For the purpose of the present invention, the term “non-cariogenic ingredients” is intended to mean compounds of sugar type such as allulose, polyols, fibers, starches and/or minerals.

The chewing gum according to the present invention is defined as being composed of the chewing paste defined above and mixed with gum base

The mixing can be carried out batchwise in kneading machines such as those used for the production of chewing gum or in continuous processes of single-screw or twin-screw type.

The jacket is preferentially heated in order to facilitate the hydration of the granules of the starch base ingredient.

The jacket temperature can reach 80° C. without constituting a cooking phase. This temperature also depends on the temperature range for gelatinization of the starch base ingredient used, for example in the case of the use of cold-usable starch.

The mixing steps have been optimized in order to maximize the properties of the ingredients used and in particular to take into account the particle size thereof.

More particularly, the process in accordance with the invention comprises the following steps:
1) preparing the liquid phase, composed of starch and polyol syrup,
2) optionally, adding glycerol and/or emulsifier and/or flavorings,
3) introducing into the liquid phase thus obtained a powder fraction composed of non-cariogenic ingredients, and
4) introducing the gum base.

Optionally, the process also comprises a rolling or extrusion step and optionally a chewing gum recovery and storage step

Preferably, the process is carried out at a temperature of less than 100° C., preferably at a temperature of less than 90° C., in particular at a temperature of between 30-80° C., 50-80° C., 40-70° C., 50-70° C., 40-60° C. or 40-60° C., for example at approximately 50° C.

In the present invention for preparing no-bake chewing paste, the texturizing of the chewing paste is carried out according to steps 1 to 3 of the production process. It is thus the combination of sequentially mixed starch, polyols and non-cariogenic ingredients which makes it possible to texturize the chewing paste without having to cook it.

The production process of the present invention concentrates first on the implementation of the chewing paste (steps 1 to 3) and then on the mixing thereof with the gum base (step 4) in order to achieve the production of a chewing gum.

The First Step Consists in Preparing the Liquid Phase, Composed of Starch and Polyol Syrup.

The polyol syrups are chosen from maltitol, sorbitol, mannitol, erythritol, xylitol, iditol, isomalt or lactitol syrups and hydrogenated glucose syrups, alone or as a mixture with one another, and are more particularly maltitol or sorbitol syrups or a mixture thereof. In one particularly preferred embodiment, the polyol syrup is a maltitol syrup.

The solids content of said syrups is preferentially between 80% and 90%, preferably approximately 85%.

The temperature for quantitative determination of the syrups is between 50 and 70° C.

The percentage of incorporation of the polyol syrup into the chewing gum composition depends on the percentage of solids content of the syrups, but is between 15% and 60% by weight of the chewing gum composition, for example between 30% and 50%, preferably approximately 40% by weight of the chewing gum composition, in particular when the polyol syrup has a solids content of between 80% and 90% by weight.

According to one alternative embodiment of the invention, the polyol syrup is introduced into the chewing gum composition, in particular during step 1), in an amount of between 15% and 45% by weight of the chewing gum composition, preferably between 20% and 45%, or between 30% and 45% or between 25% and 35%, for example approximately 30%, in particular when the polyol syrup has a solids content of between 80% and 90% by weight.

According to another alternative embodiment of the invention, the polyol syrup is introduced into the chewing gum composition, in particular during step 1), in an amount of between 15% and 60% by weight of the chewing gum composition, preferably between 20% and 50%, between 25% and 45% or between 30% and 40%, for example approximately 30% or approximately 40%, in particular when the polyol syrup has a solids content of between 80% and 90% by weight.

The starches are chosen from native starches, gelatinized starches and starch derivatives, more particularly starch hydrolysates.

This ingredient will bind a small amount of water in the final product and thus contribute to the stability thereof over time.

In the present invention, the term “native starches” denotes any starch isolated from leguminous plants, cereals or tuberous plants.

The gelatinization of said starch is understood to be the technique of aqueous dissolution of starch granules that is well known to those skilled in the art.

The starch derivatives are more particularly starch hydrolysates, even more particularly maltodextrins.

The dissolution of the starch, more preferentially of the maltodextrin, makes it possible to create a gelling network which texturizes the chewing paste.

For the purposes of the present invention, and also from the regulatory point of view, the maltodextrins have a DE (Dextrose Equivalent) of from 1 to 20. Such products are for example the maltodextrins sold by the applicant under the name Glucidex® (available DEs=1, 2, 6, 9, 12, 17, 19).

According to the invention, the maltodextrin is preferably a maltodextrin having a DE of less than 10, and even more preferentially a maltodextrin having a DE of less than 5.

According to one particularly advantageous embodiment of the invention, the maltodextrin has a DE equal to 2.

The starch base ingredient, whatever it is, must remain in as low a percentage as possible so as not to compromise the non-cariogenic nature of the final product.

Thus, the amount of starch is between 3% and 6% by weight of the chewing gum composition, for example between 4% and 6%, preferably approximately 5% by weight of the chewing gum composition.

In one alternative embodiment of the invention, the the amount of starch is between 2% and 7% by weight of the chewing gum composition, for example between 2% and 6%, between 2% and 5% or between 2% and 4%, preferably approximately 3% by weight of the chewing gum composition. In particular, the amount of starch may be between 2% and 7% by weight of the chewing gum composition, for example between 2% and 6%, or between 3% and 5%, preferably approximately 3% or 5% by weight of the chewing gum composition.

In this first step of the process in accordance with the invention, the liquid phase is mixed in order to maximally hydrate the (gelatinized or non-gelatinized) starch or the maltodextrin The polyol syrup must be such that it does not introduce too much water into the final mixture. Thus, a cooking phase at 100° C. required in order to allow evaporation of the water can be avoided by means of the process according to the present invention. The addition of the non-cariogenic ingredients (polyols and plant fibers) in a subsequent step will make it possible to increase the consistency of the chewing paste.

Thus, the solids content of the polyol syrup must be sufficiently high so as not to introduce too much water into the final recipe, which would make it much too tacky for the production and preservation of the product. Too low a solids content value would also require cooking in order to increase this content. Nevertheless, too high a solids content would make the syrup more difficult to handle with storage and handling temperatures above 70° C.

Moreover, a minimum amount of water is required in order to be able to initiate the hydration of the native starch base ingredient(s). Starch can fix up to 0.5 g of water per gram of starch. The amounts of water absorbed are about from 40% to 50% with radial swelling of the grain. A waxy corn produces an increase in the grain diameter of about 80% and a 6-fold multiplication of its volume. The water would mainly be associated with the amorphous parts. The heating, with an excess of water, of a suspension of starch at temperatures greater than 50° C. leads to irreversible swelling of the grains and results in solubilization thereof. As for gelatinized starches, they have swelling start temperatures of less than 50° C. For a given temperature range (gelatinization range), the starch grain will very rapidly swell and will lose its semicrystalline structure (loss of birefringence). A starch paste which consists of swollen grains that constitute the dispersed phase and of dispersed molecules (mainly amylose) that thicken the aqueous continuous phase is obtained. The rheological properties of the starch paste depend on the relative proportion of these two phases and on the volume of swelling of the grains. The gelatinization range is variable depending on the botanical origin of the starch. The maximum viscosity is obtained when the starch paste contains a large number of very swollen grains. When heating is continued, the grains will burst and the material will become dispersed in the medium. However, the solubilization will take place only for temperatures greater than 100° C. Reducing the temperature (by cooling) of the starch paste causes insolubilization of the macromolecules and phase separation due to the incompatibility between amylose and amylopectin, and then crystallization of these macromolecules is observed. This phenomenon is known as retrogradation. When a starch paste contains amylose, it is this first molecule that will undergo retrogradation. It consists of the formation of double helices and the linking of the latter to form “crystals” that will give a three-dimensional network by means of a joining zone. This network is formed very rapidly, in a few hours. During the production of this network, the linking together of the double helices by means of hydrogen bridge bonding displaces the water molecules linked to the helices and causes considerable syneresis While some monosaccharides can reduce the gelatinization range, saccharides in general increase said range by mobilizing the water of the environment to the detriment of the structures of the starch grain

For this reason, the amount of water introduced by the liquid phase must at least be equal to the percentage of starch base ingredients introduced into this first phase. For example, the weight ratio between the amount of water introduced by the polyol syrup and the amount of starch and of starch hydrolysate (in particular maltodextrin) is between 1 and 2, preferably between 1 and 1.5.

The syrup temperature must be at least 50° C. during its introduction into the mixing process, preferentially between 50 and 80° C. The temperature of the solution makes it possible to increase the rate of dissolution and to compensate for the high values of solids extract of the mixture.

Moreover, the mixing time must be sufficient to initiate this swelling. This time is very variable depending on the formula, type of ingredients, water/starch base ingredients ratio, type of syrup or type of material used. It may for example be between 3 and 10 minutes, preferably from 3 to 7 minutes, for example approximately 5 minutes.

The rotational speed of the blades of at least 10 rpm must provide homogeneous mixing and must render uniform the temperature of the mixture, which must be at most 80° C. in order to avoid any evaporation.

The Second Step Optionally Consists of the Addition of Glycerol and/or of Emulsifier and of Flavorings.

The “minor” ingredients are added here to the recipe, that is to say ingredients that are important for the final product but that will not introduce any major modifications regarding the chewing gum production process.

In other words, these ingredients can be introduced in any step of the process in accordance with the invention.

If they are introduced in the first step of the process in accordance with the invention, they must not compete with the available water (for instance glycerol which has a very high affinity for water) and thus compete with the other ingredients.

However, all or some of these ingredients are introduced in this second step of the process in accordance with the invention, since the incorporation thereof is easier that way.

For example, a water-soluble dye will disperse more rapidly and uniformly in this liquid phase.

The ingredients have functionalities such as acidifying, humectant, plasticizing or aromatic functionalities, and are introduced in amounts as exemplified below.

For example, from 0.1% to 8%, by weight of the chewing gum composition, of functional ingredients as described above, preferentially from 0.1% to 3% of at least one flavoring, by weight of the chewing gum composition, will be added

These functional ingredients are for example:
Synthetic and/or natural elastomers, such as polyisoprene, polyvinyl acetate, polyisobutylene, latexes, resins such as terpene resins, polyvinyl alcohols and esters,
fats or waxes, for instance lanolin, partially hydrogenated or non-hydrogenated plant oils, fatty acids, partial esters of glycerol, paraffin, microcrystalline waxes,
bulking agents such as talc, calcium carbonate,
elastomer plasticizers such as glyceryl triacetate, glyceryl monostearate, rosin derivatives,
glycerol, acids, bicarbonates or magnesium stearate,
liquid, powdered or encapsulated flavorings,
emulsifiers such as lecithin, sorbitol esters,
intense sweeteners, dyes or bleaching agents,
antioxidants,
non-stick agents such as mannitol.

The mixing is generally quite short, approximately 2 to 5 minutes.

The Third Step Consists of the Introduction into the Liquid Phase Thus Obtained of a Powder Fraction Composed of Non-Cariogenic Ingredients.

For the purpose of the present invention, the term “non-cariogenic ingredients” is intended to mean compounds of sugar type such as allulose, polyols, fibers, starches, minerals.

Their function here is that of a bulking agent.

Preferably, the bulk sweeteners consist of polyols.

The powdered polyol is chosen from maltitol, sorbitol, mannitol, erythritol, xylitol, iditol, isomalt and lactitol, and mixtures thereof, and is more particularly maltitol.

The powdered polyol may advantageously be a dehydrated polyol syrup. In particular, the powdered maltitol may advantageously be a dehydrated maltitol syrup.

More particularly, the polyol is introduced in a content of between 0.1% and 50% by weight of the chewing gum composition, for example between 1% and 40%, between 2% and 30% or between 3% and 20%, more preferentially from 5% to 15%.

In another embodiment of the invention, the polyol is introduced in a content of between 20% and 60% by weight of the chewing gum composition, for example between 25% and 55% or between 30% and 55%, preferentially from 35% to 50%.

Thus, the polyol is introduced in a content of between 0.1% and 60% by weight of the chewing gum composition, for example between 1% and 55%, between 2% and 50% or between 5% and 50%.

The fiber, for its part, is a soluble plant fiber chosen from fructans, including fructooligosaccharides (FOSs) and inulin, glucooligosaccharides (GOSs), isomaltooligosaccharides (IMOs), trans-galactooligosaccharides (TOSs), pyrodextrins, polydextrose, branched maltodextrins, indigestible dextrins or soluble oligosaccharides derived from oleaginous or protein-producing plants.

In one embodiment of the present invention, the fiber is introduced into this mixture in a content, expressed by weight relative to the total weight of the chewing gum, of 0% to 55%, preferably 0.1% to 50% by weight of the chewing gum composition, for example between 1% and 45%, between 2% and 40%, between 3% and 35%, more preferentially from 10% to 30% and even more preferentially from 15% to 25%. In one preferred embodiment, the fibers are branched maltodextrins.

The term “soluble fiber” is intended to mean water-soluble fibers. The fibers may be quantitatively determined according to various AOAC (Association of Official Analytical Chemists) methods. Mention may be made, by way of example, of AOAC methods 997.08 and 999.03 for fructans, FOSs and inulin, AOAC method 2000.11 for polydextrose, AOAC method 2001.03 for quantitatively determining the fibers contained in branched maltodextrins and indigestible dextrins, or AOAC method 2001.02 for GOSs and also soluble oligosaccharides derived from oleaginous or protein-producing plants. Among the soluble oligosaccharides derived from oleaginous or protein-producing plants, mention may be made of soya, rapeseed or pea oligosaccharides.

According to one advantageous embodiment of the present invention, the chewing gum comprises a mixture of a maltodextrin and soluble plant fibers which are branched maltodextrins.

The term “branched maltodextrins (BMDs)” is intended to mean the specific maltodextrins identical to those described in patent EP 1 006 128 of which the applicant is the proprietor. These BMDs have the advantage of representing a source of indigestible fibers beneficial to the metabolism and to intestinal equilibrium.

According to the present invention, said branched maltodextrins are characterized in that they contain between 15% and 50% of 1,6-glucosidic bonds, preferentially between 22% and 45%, more preferentially between 20% and 40%, and even more preferentially between 25% and 35%, a reducing sugar content of less than 20%, preferentially between 2% and 20%, more preferentially between 2.5% and 15%, and even more preferentially between 3.5% and 10%, a polydispersity index of less than 5, preferentially of between 1 and 4, more preferentially between 1.5 and 3, and a number-average molecular weight (Mn) of less than 4500 g/mol, preferentially of between 400 and 4500 g/mol, more preferentially between 500 and 3000 g/mol, even more preferentially between 700 and 2800 g/mol, even more preferentially of between 1000 and 2600 g/mol.

In particular, use may be made of BMDs having between 15% and 35% of 1-6-glucosidic bonds, a reducing sugar content of less than 20%, a weight-average molecular weight Mw of between 4000 and 6000 g/mol and a number-average molecular weight Mn of between 250 and 4500 g/mol.

Certain BMD subfamilies described in the abovementioned application can also be used in accordance with the invention. These are, for example, high-molecular-weight BMDs having a reducing sugar content at most equal to 5 and an Mn of between 2000 and 4500 g/mol. Low-molecular-weight BMDs having a reducing sugar content of between 5% and 20% and a number-average molecular weight Mn of less than 2000 g/mol can also be used.

In another advantageous embodiment of the present invention, use may also be made, in accordance with the invention, of the hypoglycemic hyperbranched maltodextrins described in application FR 1251810 of which the applicant is the proprietor.

According to one particularly advantageous mode of the present invention, the chewing gum comprises Nutriose®, which is a complete range of soluble fibers, recognized for their benefits, and manufactured and sold by the applicant. The products of the Nutriose® range are partially hydrolyzed wheat or corn starch derivatives which contain up to 85% of fiber. This richness in fiber makes it possible to increase digestive tolerance, to improve calorie control, to prolong energy release and to obtain a lower sugar content. Furthermore, the Nutriose® range is one of the best tolerated fibers available on the market. It shows a higher digestive tolerance, enabling better incorporation than other fibers, which represents real dietary advantages.

There are many advantages to adding fibers and more particularly branched maltodextrins such as Nutriose® to the chewing gum of the present invention. In addition to the nutritive aspect and the intake of very well-tolerated fibers by the organism, the addition of these fibers also has a not insignificant technical value. This is because these fibers consist of long polymeric glucidic chains and thus act as a texturizing agent in the chewing gums. The presence of fibers thus further makes it possible to increase the elasticity of the final product.

Thus, the durability of the chewability is increased by the presence of these long chains which modify the texture of the product. Their branched nature considerably and advantageously decreases their tendency to retrograde, thereby making it possible to envision their use in jellied confectionery items

The presence of branched maltodextrins makes it possible to avoid “cold flow” phenomena encountered in the confectionery items produced by casting on a cooling table after cooking of all the ingredients. In this type of production process, the “cold flow” phenomenon can be observed. The term “cold flow” is the ability of the chewing paste to deform without any applied force. It is therefore under the effect of its own weight that the confectionery item will tend to run and crush. This is a fault that confectioners are absolutely trying to avoid.

The presence of branched maltodextrins also makes it possible to increase the glass transition temperature or Tg of the amorphous portion of said confectionery item. This increase in the Tg makes it possible to stiffen the structure within the confectionery item and consequently makes it possible to introduce good chewability strength.

This addition of non-cariogenic ingredients in this step makes it possible to increase the volume of the mixture and to obtain a smooth paste.

These are the bulking agents of the chewing paste.

The choice of ingredients is important (amorphous or crystalline type, particle size, coextrusion, atomization) in order to minimize the powdery sensation in the mouth.

Indeed, if it is desired to obtain a smooth texture in the mouth similar to a chewing paste, it is important to have crystals which are very fine or particles which will rapidly hydrate and dissolve in the mouth.

For that, the non-cariogenic ingredient powder(s), in particular the polyol powder(s) and/or the fiber powder(s), in particular branched maltodextrin powder(s), will have to have an average particle size of less than 300 microns, preferably less than 150 microns and even more preferentially less than 100 microns. In particular, the polyols will have to have an average particle size of less than 300 microns, preferably less than 150 microns and even more preferentially less than 100 microns.

For example, the non-cariogenic ingredient powder(s), in particular the polyol powder(s) and/or the fiber powder(s), in particular branched maltodextrin powder(s), may have an average particle size of between 10 and 300 microns, between 10 and 200 microns or between 10 and 100 microns, preferably between 20 and 200 microns or between 20 and 100 microns.

These particle size measurements are carried out on the Mastersizer 3000 from Malvern, in Aero S powder mode (with a hopper opening: between 1 and 2 mm, Pressure: 0 Bar, Vibrations: between 50% and 75%).

Specific examples of ingredients with their particle size are described below.

| Ingredients | Particle size (μm) |
|---|---|
| Nutriose ® FB06 powder | 100 |
| Neosorb ® P100T | 140 |
| Xylisorb ® 90 | 90 |
| Xylisorb ® 300 | 300 |
| SweetPearl ® 25FD | 25 |
| dehydrated syrup | |
| Mannitol 35 | 55 |
| Neosorb ® P60W | 300 |
| SweetPearl ® P35 | 40 |
| SweetPearl ® P90 | 90 |
| SweetPearl ® 300FD | 280 |
| dehydrated syrup | |

The products of the Neosorb® range sold by the applicant company are polyalcohols obtained by catalytic hydrogenation of a hydrolysate of starch, more particularly of sorbitol, obtained by glucose hydrogenation.

The products of the the Nutriose® range sold by the applicant company are partially hydrolyzed wheat or corn starch derivatives which contain up to 85% of plant fibers.

The products of the Sweet Pearl® range sold by the applicant company contain 92% of maltitol and 8% of hydrogenated carbohydrates.

The products of the Xylisorb® range sold by the applicant company are xylitol.

A polyol containing other hydrogenated carbohydrates may also accelerate the hydration by saliva.

For example, SweetPearl® 25FD sold by the applicant company contains 92% of maltitol and 8% of hydrogenated carbohydrates, which facilitates its dissolution.

Moreover, the atomizing of a crystalline polyol with an amorphous solution makes it possible to increase its solubility and to thus decrease the rough aspect in the mouth.

The fibers may be part of the bulking agent of the chewing paste. According to the same principle as for the polyols, the average particle size will be in the same values.

The powders are introduced gradually in order to ensure homogeneous mixing. The mixing time is between 3 and 10 minutes in a conventional kneading machine as a function of the amounts to be introduced.

The result of the mixing according to steps 1 to 3 of the process according to the invention is similar to a sugar-free, fat-free and gelatin-free chewing paste.

According to one embodiment of the process according to the invention, it may be chosen to split the introduction of the powder fraction composed of non-cariogenic ingredients into the liquid phase into at least two distinct steps, so as to have better control of the viscosity of the paste obtained, the mixing time and/or the quality of the mixture.

According to one embodiment of the invention, the process comprises a step 5) of adding an additional powder fraction composed of non-cariogenic ingredients.

According to one embodiment of the invention, at least 30% of the powder fraction composed of non-cariogenic ingredients is introduced in step 3) and the remainder of the powder fraction is introduced in step 5).

According to another embodiment of the invention, between 30% and 80%, between 40% and 60%, preferentially between 50% and 75% of the powder fraction composed of non-cariogenic ingredients is introduced in step 3) and the remainder of the powder fraction is introduced in step 5).

According to one preferred embodiment of the invention, at least 50% of the powder fraction composed of non-cariogenic ingredients is introduced in step 3) and the remainder of the powder fraction is introduced in step 5).

It is thus recommended:
to introduce at least 50% of the powder fraction composed of non-cariogenic ingredients into the liquid phase,
to introduce the gum base and
to complete with the remaining portion of said powder fraction.

The Fourth and Final Step Consists of the Introduction of the Gum Base

The introduction of the gum base into the chewing paste results in the obtaining of a chewing gum. The gum base is introduced in this step in a content of from 10% to 25% by weight of the chewing gum composition, at a temperature of at most 95° C.

For example, the gum base is present in the chewing gum composition in an amount of between 10% and 25%, between 12% and 23%, between 15% and 20% by weight of the chewing gum composition, preferably approximately 18%.

The recipe of the gum base often remains secret since it is not constant. It varies according to the price of the raw material. The nature the nature of the gum base is also adapted to the type of chewing gum produced. It may comprise synthetic and/or natural elastomers, such as polyisoprene, polyvinyl acetate, polyisobutylene, latexes, resins such as terpene resins, polyvinyl alcohols and esters.

In this fourth step, the gum base can be heated in order to lower its viscosity and to pass above its Tg (glass transition) point.

In this case, it acquires a viscoelastic and rubbery behavior.

When approaching the softening point of the gum base, the viscosity of the latter decreases and this facilitates the dispersion of the gum base in the mixture.

The softening point of a gum base is generally between 50 and 100° C. This softening of the material introduces only very little thermal energy into the final mixture and at no point does it represent cooking since the final temperature of the product preferably remains below 60° C.

The other ingredients, such as intense sweeteners, dyes, liquid, powdered or encapsulated flavorings, acids, bicarbonates, magnesium stearate, can be introduced during the preparation of said chewing paste or after the introduction of the gum base.

Compared with the recipe for a chewing gum containing a chewing paste with cooking according to the teaching of patent application WO 2016/001191, the ingredients dissolved during the preparation partially recrystallize as fine crystals that are imperceptible in the mouth. When the crystallization is well controlled, the particle size is generally less than 25 microns.

In the case of the present invention, there is no cooking and a very small portion of the ingredients recrystallizes. The starting ingredients are thus barely modified in the final product, hence the importance of the particle size of the compounds for a pleasant aspect of the chewing paste and/or of the chewing gum in the mouth, in particular that of the powder fraction composed of non-cariogenic ingredients.

The advantage is thus that of obtaining a product that is as smooth as possible in the mouth and that is preserved over time.

Thus, in a very particular embodiment of the invention, the present invention relates to a process for producing a chewing gum composition containing a fat-free and gelatin-free chewing paste, comprising the following steps:
1) preparing the liquid phase, composed of starch and polyol syrups,
2) optionally, adding glycerol and/or emulsifier and/or flavorings,
3) introducing into the liquid phase thus obtained a powder fraction composed of non-cariogenic ingredients including a polyol and/or a fiber, and
4) introducing the gum base,
characterized in that
   said process is carried out at a temperature of less than 100° C., preferably at a temperature of less than 90° C., in particular at a temperature of between 30-80° C., preferably between 50 and 80° C., for example at approximately 50° C.;
   the polyol syrup is introduced in an amount of between 15% and 60% by weight of the chewing gum composition, preferably between 20% and 50%, between 25% and 45% or between 30% and 40%, for example approximately 30% or approximately 40%, in particular when the polyol syrup has a solids content of between 80% and 90% by weight;
   the starch is introduced in an amount of between 2% and 7% by weight of the chewing gum composition, for example between 2% and 6%, or between 3% and 5%, preferably approximately 3% or 5% by weight of the chewing gum composition;
   the weight ratio between the amount of water introduced by the polyol syrup and the amount of starch is between 1 and 4, preferably between 1 and 2, more preferentially between 1 and 1.5;
   the non-cariogenic ingredient powder(s) have an average particle size of less than 300 microns, preferably less than 150 microns and even more preferentially less than 100 microns;
   the fiber is introduced in an amount of from 0% to 55% by weight of the chewing gum composition, for example between 1% and 45%, between 2% and 40%, between 3% and 35%, more preferentially from 10% to 30% and even more preferentially from 15% to 25%;
   the polyol powder is introduced in an amount of between 0.1% and 60% by weight of the chewing gum composition, for example between 1% and 55%, between 2% and 50% or between 5% and 50%; and
   the gum base is present in the chewing gum composition in an amount of between 10% and 25%, between 12% and 23%, between 15% and 20% by weight of the chewing gum composition, preferably approximately 18%.

The chewing gum composition containing a chewing paste obtained by means of the process according to the invention comprises powdered polyols which have an average particle size of less than 300 microns, preferably less than 150 microns, even more preferentially less than 100 microns.

The chewing gum composition, preferably fat-free and sugar-free chewing gum composition, thus obtained comprises a final moisture content of at least 2%, preferably of at least 3%, even more preferentially between 4% and 8%. This moisture content comes predominantly from the liquid phase but also from the other ingredients.

The chewing gum composition, preferably fat-free and sugar-free chewing gum composition, thus obtained comprises between 20% and 60% by dry weight of the chewing gum composition of polyols and of starch, preferably of maltodextrin and of maltitol, preferably between 30% and 50%.

The chewing gum composition, preferably fat-free and sugar-free chewing gum composition, thus obtained comprises polyols, starch, gum base, polyol powder and optionally fibers.

The composition may comprise these various components in the following amounts:
the polyol originating from polyol syrup in an amount of between 10% and 55% by weight of the chewing gum composition, preferably between 15% and 45%, between 20% and 40% or between 25% and 35%; the polyol preferably being maltitol;
the starch in an amount of between 2% and 7% by weight of the chewing gum composition, for example between 2% and 6%, or between 3% and 5%, preferably approximately 3% or 5% by weight of the chewing gum composition; the starch preferably being maltodextrin;
the fiber in an amount of from 0% to 55% by weight of the chewing gum composition, for example between 1% and 45%, between 2% and 40%, between 3% and 35%, more preferentially from 10% to 30% and even more preferentially from 15% to 25%; preferably in powder form; the fiber preferably being a branched maltodextrin;
the polyol powder is introduced in an amount of between 0.1% and 60% by weight of the chewing gum composition, for example between 1% and 55%, between 2% and 50% or between 5% and 50%; the polyol being maltitol; and
the gum base is present in the chewing gum composition in an amount of between 10% and 25%, between 12% and 23%, between 15% and 20% by weight of the chewing gum composition, preferably approximately 18%.

Preferably, the chewing gum composition, preferably fat-free and sugar-free chewing gum composition, thus obtained comprises maltitol, maltodextrin, gum base, maltitol powder and branched maltodextrins.

The polyol powder, in particular maltitol powder, has an average particle size of less than 300 microns, preferably less than 150 microns and even more preferentially less than 100 microns. In particular, the average particle size may be between 10 and 300 microns, between 10 and 200 microns or between 10 and 100 microns, preferably between 20 and 200 microns or between 20 and 100 microns.

The term “approximately” is intended to mean the value plus or minus 10%, preferably plus or minus 5%. For example, approximately 100 means between 90 and 110, preferably between 95 and 105.

The invention will be understood more clearly with the aid of the following examples which are intended to be illustrative and nonlimiting.

### EXAMPLES

### Example 1: Preparation of the Sugar-Free Chewing Gum According to the Process of the Invention

Two recipes, A and B, are produced with the ingredients presented in the following table.

| Chewing gum according to the invention | Recipe A | Recipe B |
|---|---|---|
| SOLSONA T gum base from Cafosa | 18.00 | 18.00 |
| SWEETPEARL ® 25FD from ROQUETTE | 9.90 | |
| SWEETPEARL ® 300FD from ROQUETTE | | 9.90 |
| Waxy N200 from ROQUETTE | 1.50 | 1.50 |
| LYCASIN ® 85/55 - maltitol syrup from | 42.00 | 42.00 |
| ROQUETTE | | |
| Glycerol | 1.00 | 1.00 |
| GLUCIDEX ® 2 from ROQUETTE | 4.38 | 4.38 |
| NUTRIOSE ® FB06 from ROQUETTE | 20.00 | 20.00 |
| Fresh Mint Liquor M0060136 from Mane | 0.45 | 0.45 |
| Fresh Mint SD M0060167 from Mane | 2.00 | 2.00 |
| Acesulfame K | 0.12 | 0.12 |
| Sucralose | 0.15 | 0.15 |
| Physcool Powder from Mane | 0.50 | 0.50 |
| | 100.00 | 100.00 |

The mixing is carried out on a 200 gram IKa kneading machine, the jacket of which is heated to 50° C.

The blades have a rotational speed of 30 rpm.

All the ingredients are weighed and the maltitol syrup and also the gum base are stored in an oven at 50° C. for 3 heures.

The mixing cycle is the following:
0 min Introduction of all of the the LYCASIN® 85/55 (maltitol syrup) and GLUCIDEX® 2 (maltodextrin).
   Initiation of the mixing
5 min Introduction of the glycerol and of the N200 waxy starch
6 min Introduction of the NUTRIOSE® FB06 then of the SWEETPEARL® 25 FD or 300 FD
8 min Introduction of the liquid flavoring and of the intense sweeteners
10 min Introduction of the gum base
12 min Introduction of the powder flavorings
14 min End of kneading

The paste temperature at the end of mixing is about 45-55° C.

The paste is left to cool to a temperature of 30 and 40° C., before the conventional phase of forming in the form of a strip, then rolling and finally cutting up.

Discussion

The long carbohydrate chains of the maltitol syrup will provide the chewing paste structure.

The use of LYCASIN® 85/55 at 85% solids content makes it possible to increase the degree of use thereof to 42%. This provides a considerable amount of dissolved, and therefore non-granular, product without generating a paste that is too tacky.

The maltodextrin, GLUCIDEX® 2, will serve as a water retainer and thus will serve to improve the preservation of the product. It can be easily replaced with a pregelatinized starch of PREGEFLO® C100 type which also does not require a high gelatinization temperature.

The syrup water/GLUCIDEX® 2 ratio of 1.4 makes it possible to maximize the contact between these 2 products.

Moreover, mixing instead at 50° C. and for 3 to 5 minutes contributes to this optimization.

As previously explained, the bulking agents of a sugar-free chewing gum are predominantly crystalline and give a rough texture.

In order to achieve a texture close to a chewing paste with cooking, the parameters which influence the dissolution of the ingredients were observed.

Certain parameters are not accessible to any modifications, such as the temperature of the mouth, the acidity of the product, etc.

The applicant company therefore worked on the exchange surface and the morphological choice of the ingredients.

The more finely divided a powder is, the faster its rate of dissolution. It is with this perspective that the powders used were selected or milled so as to have a particle size of less than 150 microns and preferentially less than 100 microns.

A product having crystallinity defects experiences an increase in its solubility rate.

SWEETPEARL® 25FD has a fine particle size and was manufactured with a syrup of lower richness, of about 92%.

The atomization of a fine crystalline powder using a solution of amorphous type makes it possible to increase the hygroscopicity of the powder.

In addition, the mannitol can be atomized with a solution of soluble fiber of NUTRIOSE® FB06 type.

All the compounds can be placed in this amorphous state; example, by cooling them in their liquid form without them crystallizing, in particular by evaporating off the solvent of the solution without the solute crystallizing.

Milling can also give products which are totally or partially more or less amorphous.

An amorphous product is generally extremely soluble in solvents in which the corresponding crystalline solid is soluble.

The dissolution rate can moreover be very fast, all the more if said product is finely divided.

The bulking agents used are:
the NUTRIOSE® FB06 soluble fiber for its amorphous aspect, milled to a particle size of less than 100 microns, and
a fast-dissolving maltitol, SweetPearl 25 FD.

Waxy starch of fine particle size provides a “fatty” sensation in the mouth.

Glycerol acts as a buffer for preservation.

If the final product is in a dry environment, that is to say less than 40% RH (relative humidity), its high-water-affinity nature (Aw of about 0.13 at 20° C.) makes it possible to retain a maximum amount of said water.

Since the formula of the final product already contains 5% water, its action in humid environments (greater than 70% RH) remains limited.

The “minor” ingredients are there to provide the aromatic and sweet taste.

The chewing paste mixture is sufficiently cohesive to be able to reduce the percentage of gum base. Thus, with 18% of gum base, the paste has a degree of pulling equivalent to a standard chewing gum on the market. The paste can be extruded and can thus form chewing gum pieces.

Sensory Analyses

The organoleptic analyses on the product show sensory attributes different from a chewing gum, namely:
a lower hardness as soon as it is placed in the mouth,
a hydration faster than a chewing gum,
an initial texture closer to a chewing paste than that of a chewing gum,
a greater aromatic impact and an increased sensation of juiciness.

After 1 minute, the product rapidly transforms into conventional chewing gum.

Recipe B has a chewing paste texture at the start, flexible but the particle size of SWEETPEARL® 300FD is still too high.

Recipe A is characteristic of a chewing paste, flexible, smooth, juicy at the start of chewing, then the pleasant chewing of a chewing gum is experienced.

The fine particle size of SWEETPEARL® 25FD makes it possible to reduce the sensation of crystals in the mouth.

### Example 2: Comparative Example of Production of Sugar-Free Chewing Gum

Two recipes are in this case developed:
Recipe C: Production of a chewing gum containing chewing paste with cooking according to the teaching of patent application WO 2016/001191, and
Recipe C: Production of a conventional chewing gum.

Composition of Recipe C

| | |
|---|---|
| Mannitol 60 | 15.00 |
| Flama T gum base - Cafosa SA | 23.00 |
| Strawberry liquid flavoring E1422791 - Mane SA | 0.30 |
| Physcool powder - Mane SA | 0.50 |
| Sucralose | 0.15 |
| Acesulfame K | 0.12 |
| Strawberry powder flavoring - Mane SA | 2.00 |
| Glycerol | 1.00 |
| Citric acid | 1.00 |
| Malic acid | 0.50 |
| Chewing paste | 56.43 |
| | 100.00 |

The mixing is carried out on a 200 gram Ika kneading machine with a jacket heated to 50° C.

Beforehand, the chewing paste will have been prepared in a cooker at a temperature of 126° C. in order to increase its solids extract by about 15 points, i.e. approximately 92% solids content in the end (cf. cooking conditions of example 1 of patent application WO 2016/001191).

This paste is cooled to below 80° C. in order to develop the crystallization and to subsequently meter into the mixer at a temperature of about 60° C.

The mixing cycle is the following:

| | |
|---|---|
| 0 min | Introduction of the gum base preheated to 50° C. and of the |
| | mannitol. |
| 5 min | Introduction of the glycerol. |
| 6 min | Introduction of the liquid flavoring, the intense sweeteners and |
| | the acids. |
| 8 min | Introduction of the chewing paste preheated to 50° C. |
| 12 min | Introduction of the powder flavorings. |
| 14 min | End of kneading. |

The forming and cutting up process is identical to that described in recipes A & B. Since the characteristics of the pastes are similar, flexible, cohesive, etc., paste, the production parameters will be similar.

Composition of Recipe D

| | |
|---|---|
| Gum base | 30.00 |
| NEOSORB ® P60 W sorbitol | 47.73 |
| Mannitol 60 | 7.00 |
| LYCASIN ® 85/55 Maltitol sirop (85% DS) | 11.00 |
| Glycerol | 1.00 |
| Powder flavoring | 1.50 |
| Liquid flavoring | 1.50 |
| Acesulfame K | 0.12 |
| Sucralose | 0.15 |
| | 100.00 |

The mixing will be carried out on a 200 gram Ika kneading machine with a jacket heated to 50° C.

The mixing cycle is the following:

| | |
|---|---|
| 0 min | Introduction of the gum base preheated to 50° C. and half |
| | the sorbitol. |
| 5 min | Introduction of the glycerol, Lycasin 85/55 preheated to 50° C. |
| 7 min | Introduction of the mannitol and of the intense sweeteners. |
| 8 min | Introduction of the remaining half of the sorbitol. |
| 10 min | Introduction of the liquid flavoring. |
| 12 min | Introduction of the powder flavoring. |
| 14 min | End of kneading. |

The paste temperature at the end of mixing is about 45-55° C.

The paste is left to cool to a temperature of 30 and 40° C., before the conventional phase of forming in the form of a strip, then rolling and finally cutting up.

Discussion

Recipe C with chewing paste and with cooking gives a product which is very flexible at first chewing, and a rapid hydration which releases a strong aromatic intensity.

The juicy attribute is greatly improved, as is a smooth chewing in the mouth.

Furthermore, despite a low percentage of gum base, the sensation of volume in the mouth remains high. The recipes of said chewing gum with no-bake chewing paste have very similar characteristics.

Recipe D of the conventional chewing gum reveals sensory attributes which are opposite those previously mentioned. These are, namely, a considerable initial hardness, a rough product that is difficult to hydrate, and the aromatic perception of which takes time to come out.

After 3 minutes of chewing, the perception in the mouth becomes more similar since the majority of the soluble phase has disappeared and only the gum base gives the feeling of chewing. The product clearly has a soft, smooth bite similar to a conventional chewing paste and subsequently becomes a chewing gum.

1. A process for producing a chewing gum composition containing a fat-free and gelatin-free chewing paste, comprising the following steps:
1) preparing the liquid phase, composed of starch and polyol syrups,
2) optionally, adding glycerol and/or emulsifier and/or flavorings,
3) introducing into the liquid phase thus obtained a powder fraction composed of non-cariogenic ingredients, and
4) introducing the gum base,
characterized in that said process is carried out at a temperature of less than 100° C., preferably at a temperature of less than 90° C., in particular at a temperature of between 30-80° C., preferably between 50-80° C., for example at approximately 50° C.

2. The process as claimed in claim 1, characterized in that it comprises a step 5) of adding an additional powder fraction composed of non-cariogenic ingredients.

3. The process as claimed in claim 2, characterized in that at least 50% of the powder fraction composed of non-cariogenic ingredients is introduced in step 3) and the remainder of the powder fraction is introduced in step 5).

4. The process as claimed in claim 1, characterized in that the polyol syrups introduced into the liquid phase are chosen from maltitol, sorbitol, mannitol, erythritol, xylitol, iditol, isomalt and lactitol syrups, and hydrogenated glucose syrups, alone or as a mixture with one another, and are more particularly maltitol or sorbitol syrups.

5. The process as claimed in claim 1, characterized in that the polyol syrup is introduced into the chewing gum composition during step 1) in an amount of between 15% and 60% by weight of the chewing gum composition, preferably between 20% and 50%, between 25% and 45% or between 30% and 40%, for example approximately 30% or approximately 40%, in particular when the polyol syrup has a solids content of between 80% and 90% by weight.

6. The process as claimed in claim 5, characterized in that the polyol syrup is introduced into the chewing gum composition during step 1) in an amount of between 20% and 60% by weight of the chewing gum composition, for example between 30% and 50%, preferably approximately 40% by weight of the chewing gum composition, in particular when the polyol syrup has a solids content of between 80% and 90% by weight.

7. The process as claimed in claim 5, characterized in that the polyol syrup is introduced into the chewing gum composition during step 1) in an amount of between 15% and 45% by weight of the chewing gum composition, preferably between 20% and 45%, or between 30% and 45% or between 25% and 35%, for example approximately 30%, in particular when the polyol syrup has a solids content of between 80% and 90% by weight.

8. The process as claimed in claim 1, characterized in that the starch which is introduced into the liquid phase is chosen from native starches, gelatinized starches and starch derivatives, and is more particularly a starch hydrolysate.

9. The process as claimed in claim 8, characterized in that the starch hydrolysate is a maltodextrin, preferably a maltodextrin which has a Dextrose Equivalent (DE) of less than 10, preferentially less than 5, and even more preferentially equal to 2.

10. The process as claimed in claim 9, characterized in that the maltodextrin is introduced into the liquid phase in a content of between 2% and 7% by weight of the chewing gum composition, for example between 2% and 6%, or between 3% or 5%, preferably approximately 3% or 5% by weight of the chewing gum composition.

11. The process as claimed in claim 10, characterized in that the maltodextrin is introduced into the liquid phase in a content of between 3% and 6% by weight of the chewing gum composition, preferably about 5% by weight of the chewing gum composition.

12. The process as claimed in claim 10, characterized in that the maltodextrin is introduced into the liquid phase in a content of between 2% and 7% by weight of the chewing gum composition, for example between 2% and 6%, between 2% and 5% or between 2% and 4%, preferably approximately 3% by weight of the chewing gum composition.

13. The process as claimed in claim 1, characterized in that the weight ratio between the amount of water introduced by the polyol syrup and the amount of starch and/or of starch hydrolysate, in particular maltodextrin, is between 1 and 4, preferably between 1 and 2, more preferentially between 1 and 1.5.

14. The process as claimed in claim 1, characterized in that the non-cariogenic ingredients of the powder fraction introduced into the liquid phase are chosen from a sugar, a polyol, a soluble fiber, minerals and mixtures thereof.

15. The process as claimed in claim 14, characterized in that the powdered polyol is chosen from maltitol, sorbitol, mannitol, erythritol, xylitol, iditol, maltitol, isomalt and lactitol, and is more particularly maltitol.

16. The process as claimed in claim 15, characterized in that the polyol is a dehydrated maltitol syrup.

17. The process as claimed in claim 14, characterized in that the polyol is introduced in a content of between 0.1% and 60% by weight of the chewing gum composition, for example between 1% and 55%, between 2% and 50% or between 5% and 50%.

18. The process as claimed in claim 17, characterized in that the polyol is introduced in a content of between 0.1% and 50% by weight of the chewing gum composition, for example between 1% and 40%, between 2% and 30% or between 3% and 20%, more preferentially from 5% to 15%.

19. The process as claimed in claim 17, characterized in that the polyol is introduced in a content of between 20% and 60% by weight of the chewing gum composition, for example between 25% and 55% or between 30% and 55%, preferentially from 35% to 50%.

20. The process as claimed in claim 14, characterized in that the soluble fiber is a soluble plant fiber chosen from fructans, such as fructooligosaccharides (FOSs) and inulin, glucooligosaccharides (GOSs), isomaltooligosaccharides (IMOs), trans-galactooligosaccharides (TOSs), pyrodextrins, polydextrose, branched maltodextrins, indigestible dextrins and soluble oligosaccharides derived from oleaginous or protein-producing plants.

21. The process as claimed in claim 20, characterized in that the soluble plant fiber is a branched maltodextrin.

22. The process as claimed in claim 20, characterized in that the fiber is introduced in a content of from 0% to 55%, preferably 0.1% to 50% by weight of the chewing gum composition, for example between 1% and 45%, between 2% and 40%, between 3% and 35%, more preferentially from 10% to 30% and even more preferentially from 15% to 25%.

23. The process as claimed in claim 1, characterized in that the non-cariogenic ingredient powder(s) have an average particle size of less than 300 microns, preferably less than 150 microns and even more preferentially less than 100 microns.

24. The process as claimed in claim 23, characterized in that the non-cariogenic ingredient powder(s) have an average particle size of between 10 and 300 microns, between 10 and 200 microns or between 10 and 100 microns, preferably between 20 and 200 microns or between 20 and 100 microns.

25. The process as claimed in claim 1, characterized in that the gum base is introduced in a content of between 10% and 25%, between 12% and 23%, between 15% and 20% by weight of the chewing gum composition, preferably approximately 18%.

26. The process as claimed in claim 1, characterized in that from 0.1% to 8% of functional ingredients, by weight of the chewing gum composition by weight of the chewing gum composition, preferentially from 0.1% to 3% of at least one flavoring, are introduced into the liquid phase.

27. A chewing gum composition containing a chewing paste, said chewing paste containing a powder fraction composed of non-cariogenic ingredients comprising powdered polyols having an average particle size of less than 300 microns, preferably less than 150 microns, even more preferentially less than 100 microns, obtained by means of the process as claimed in claim 1.

28. The chewing gum composition as claimed in claim 27, characterized in that it comprises between 20% and 60%, by dry weight of the chewing gum composition, of polyols and of starch, preferably of maltodextrin and of maltitol, and a final moisture content of at least 2%, preferentially between 15% and 45% dry weight of liquid phase and a final moisture content of between 4% and 8%.

29. The chewing gum composition as claimed in claim 27, characterized in that it comprises:
the polyol originating from polyol syrup in an amount of between 10% and 55% by weight of the chewing gum composition, preferably between 15% and 45%, between 20% and 40% or between 25% and 35%; the polyol preferably being maltitol;
the starch in an amount of between 2% and 7% by weight of the chewing gum composition, for example between 2% and 6%, or between 3% or 5%, preferably approximately 3% or 5% by weight of the chewing gum composition; the starch preferably being maltodextrin;
the fiber in an amount of from 0% to 55% by weight of the chewing gum composition, for example between 1% and 45%, between 2% and 40%, between 3% and 35%, more preferentially from 10% to 30% and even more preferentially from 15% to 25%; preferably in powder form; the fiber preferably being a branched maltodextrin;
the polyol powder is introduced in an amount of between 0.1% and 60% by weight of the chewing gum composition, for example between 1% and 55%, between 2% and 50% or between 5% and 50%; the polyol being maltitol; and
the gum base is present in the chewing gum composition in an amount of between 10% and 25%, between 12% and 23%, between 15% and 20% by weight of the chewing gum composition, preferably approximately 18%.
